(19) United States
(12) Patent Application Publication
(10) Pub. No.: US 2024/0346297 A1
(43) Pub. Date: Oct. 17, 2024

(54) METHOD AND SYSTEM FOR IMPROVING ACCURACY OF MODEL QUANTIFICATION

(71) Applicant: Montage Technology Co., Ltd., Shanghai (CN)

(72) Inventor: Ruijie Wu, Shanghai (CN)

(73) Assignee: Montage Technology Co., Ltd., Shanghai (CN)

(21) Appl. No.: 18/629,007

(22) Filed: Apr. 8, 2024

(30) Foreign Application Priority Data
Apr. 12, 2023 (CN) 202310391219.8

(51) Int. Cl. G06N 3/0495; G06N 3/082

(52) U.S. Cl. CPC G06N 3/0495; G06N 3/082

(57) ABSTRACT

A method and a system for improving accuracy of model quantification includes obtaining a floating-point model with multiple floating-point layers, and calculating a cumulative original output of all floating-point layers of the floating-point model; selecting one floating-point layer from floating-point model separately each time for quantization to form multiple hybrid models each containing one quantization layer, and separately calculating error value of cumulative output of all layers of each hybrid model relative to the cumulative original output to obtain multiple calculated error values; sorting the calculated error values; and quantizing all floating-point layers of the floating-point model, and restoring corresponding quantization layer(s) to floating-point layer(s) one by one in descending order of the error values and calculating a difference between the cumulative output of all layers of a corresponding restored model and the cumulative original output until the difference is less than preset loss threshold to obtain target hybrid model.

### CROSS-REFERENCE TO PRIOR APPLICATION

This application claims priority to Chinese Application No. 202310391219.8 filed on Apr. 12, 2022, which is incorporated herein by reference in its entirety.

### TECHNICAL FIELD

The present application relates to the technical field of neural network and, in particular, to a method and a system for improving accuracy of model quantification.

### BACKGROUND

Hybrid accuracy optimization refers to that during the quantization process of neural network model, certain network layers with low accuracy cause significant errors in final result. The accuracy of these network layers need to be restored to high (such as FP32 or FP16) for calculation, to ensure that the final error of the model is within an acceptable range. Therefore, the task of hybrid accuracy optimization is to find which quantized network layers have a significant effect on the error of the final result.

The error caused by the quantization of the convolution or matrix multiplication parameters of each layer, due to the high-dimensional nonlinear of the neural network, propagates through the layers and is influenced by the quantization errors from other layers, making it impossible to directly calculate the effect of the quantization error of each layer on the final result. One traditional method is to use the error back propagation method to determine the error gradient of each quantization layer on the result. After multiple trainings on a small amount of data, the quantization layers that have a greater effect on the error of the result are found out. However, this method has the following drawbacks: 1) the error gradient propagation is not direct, because the training requires setting a lot of hyperparameters, and due to the non-parsability of the neural network, there is no guarantee that the training can converge to the optimum and there are risks such as overfitting; 2) the speed of the training is relatively slow, which requires multiple batches of data inference, as well as operations such as gradient backpropagation and parameter updates.

This section aims to provide background or context for the implementation of the application stated in the claims. The description here should not be considered prior art merely because it is included in this section.

### SUMMARY OF THE INVENTION

An object of this application is to provide a method and a system for improving the accuracy of model quantification, which can quickly identify which quantized network layers have a significant effect on the error of the result and restore the accuracy of these network layers to high, thereby optimizing the accuracy of hybrid models.

This application discloses a method for improving the accuracy of model quantization, including:
obtaining a floating-point model with multiple floating-point layers, and calculating a cumulative original output of all floating-point layers of the floating-point model;
selecting one floating-point layer from the floating-point model separately each time for quantization, so as to form multiple hybrid models each containing one quantization layer, and separately calculating an error value of cumulative output of all layers of each hybrid model relative to the cumulative original output, so as to obtain multiple calculated error values;
sorting the calculated error values; and
quantizing all floating-point layers of the floating-point model, and restoring corresponding quantization layer(s) to floating-point layer(s) one by one in descending order of the calculated error values and calculating a difference between cumulative output of all layers of a corresponding restored model and the cumulative original output until the difference is less than a preset loss threshold to obtain a target hybrid model.

In some embodiments, the floating-point model further comprises batch normalization layers, each disposed after the floating-point layer and used to normalize an output of the floating-point layer.

In some embodiments, before quantizing all floating-point layers of the floating-point model, the method further comprises removing the last layer that is a normalized exponential function layer of the floating-point model.

In some embodiments, upon the difference being less than the preset loss threshold, the method further comprises: adding a normalized exponential function layer to the target hybrid model as the last layer of the target hybrid model.

In some embodiments, the data format of the floating-point layer is: floating-point FP32 or floating-point FP16.

This application discloses a system for improving the accuracy of model quantization, including:
an acquisition module, configured to obtain a floating-point model with multiple floating-point layers, and calculate a cumulative original output of all floating-point layers of the floating-point model;
a quantization module, configured to select one floating-point layer from the floating-point model separately each time for quantization, so as to form multiple hybrid models each containing one quantization layer, and separately calculate an error value of cumulative output of all layers of each hybrid model relative to the cumulative original output so as to obtain multiple calculated error value;
a sorting module, configured to sort the calculated error values; and
a restoring module, configured to quantize all floating-point layers of the floating-point model, and restore corresponding quantization layer(s) to floating-point layer(s) one by one in descending order of the calculated error values and calculate a difference between the cumulative output of all layers of a corresponding restored model and the cumulative original output until the difference is less than a preset loss threshold to obtain a target hybrid model.

In some embodiments, the floating-point model further comprises batch normalization layers, each disposed behind the floating-point layer and used to normalize an output of the floating-point layer.

In some embodiments, before quantizes all floating-point layers of the floating-point model, the restoring module is further configured to remove the last layer that is a normalized exponential function layer of the floating-point model.

In some embodiments, upon the difference being less than the preset loss threshold, the restoring module is further configured to add a normalized exponential function layer to the target hybrid model as the last layer of the target hybrid model.

In some embodiments, the data format of the floating-point layer is: floating-point FP32 or floating-point FP16.

A large number of technical features are described in the specification of the present application, and are distributed in various technical solutions. If a combination (i.e., a technical solution) of all possible technical features of the present application is listed, the description may be made too long. In order to avoid this problem, the various technical features disclosed in the above summary of the present application, the technical features disclosed in the various embodiments and examples below, and the various technical features disclosed in the drawings can be freely combined with each other to constitute various new technical solutions (all of which are considered to have been described in this specification), unless a combination of such technical features is not technically feasible. For example, feature A+B+C is disclosed in one example, and feature A+B+D+E is disclosed in another example, while features C and D are equivalent technical means that perform the same function, and technically only choose one, not to adopt at the same time. Feature E can be combined with feature C technically. Then, the A+B+C+D scheme should not be regarded as already recorded because of the technical infeasibility, and A+B+C+E scheme should be considered as already documented.

### BRIEF DESCRIPTION OF THE FIGURES

FIG. 1 is a flow diagram of a method for improving the accuracy of model quantization according to a first embodiment of the present application.

FIG. 2 shows quantization errors on its subsequent network layers after quantizing each layer in the Mobilenet_v2 model according to one embodiment of the present application.

FIG. 3 shows quantization errors on its subsequent network layers after quantizing each layer in the Resnet50 model according to one embodiment of the present application.

FIG. 4 shows quantization errors on the last network layer after quantizing each layer and then separately quantizing the other layers in the Mobilenet_v2 model according to one embodiment of the present application.

FIG. 5 shows quantization errors on the last network layer after quantizing each layer and then separately quantizing the other layers in the shufflenet_v2_x1_0 model according to one embodiment of the present application.

FIG. 6 and FIG. 7 show quantization errors of vgg16 without BN and with BN, respectively, according to one embodiment of the present application.

FIG. 8 and FIG. 9 show quantization errors of Mobilenet_v2 model without softmax and with softmax, respectively, according to one embodiment of the present application.

FIG. 10 is a block diagram of a system for improving the accuracy of model quantization according to a second embodiment of the present application.

### DETAILED DESCRIPTION

In the following description, numerous technical details are set forth in order to provide the readers with a better understanding of the present application. However, those skilled in the art can understand that the technical solutions claimed in the present application can be implemented without these technical details and various changes and modifications based on the following embodiments.

Explanation of some concepts:

FP32 is a single-precision floating-point number, occupying 4 bytes. It includes 8 exponent bits and 23 fraction bits.

FP16 is a half-precision floating-point number, occupying 2 bytes. It includes 5 exponent bits and 10 fraction bits.

INT8 is an eight-bit integer that occupies one byte.

In order to make the objects, technical solutions and advantages of the present application clear, embodiments of the present application will be further described in detail below with reference to the accompanying drawings.

A first embodiment of the present application relates to a method for improving the accuracy of model quantification, the flowchart of which is shown in FIG. 1, and the method comprises the following steps:

Step 101, obtaining a floating-point model with multiple floating-point layers, and calculating a cumulative original output of all floating-point layers of the floating-point model. The cumulative original output is the final result of the floating-point model.

As described above, the floating-point model further comprises a plurality of batch normalization (BN) layers, and each of the BN layer is disposed behind a quantizable floating-point layer for normalizing the output of the floating-point layer. Specific information on the error localization effect of the BN layers can be found below.

In some embodiments, the data format of the floating-point layer may be floating-point FP32 or floating-point FP16.

Step 102, selecting one floating-point layer from the floating-point model separately each time for quantization, so as to form multiple hybrid models each containing one quantization layer, and separately calculating an error value of cumulative output of all layers of each hybrid model relative to the cumulative original output, so as to obtain multiple calculated error values.

It should be understood that in the step 102, only one floating-point layer in the floating-point model is quantized during each quantization process to obtain one hybrid model containing one quantization layer, and quantization process is performed once for each floating-point layer in the floating-point model, thereby obtaining multiple hybrid models each containing one quantization layer, respectively. The error value of the cumulative output of all layers in each hybrid model (i.e., the final result of the hybrid model) relative to the cumulative original output is calculated, obtaining the error values caused by each quantization layer to the final result.

For example, assuming that for the first time, the first floating-point layer in the floating-point model is selected to be quantized, then a first hybrid model in which only the first layer is a quantization layer and all other layers remain floating-point layers is formed. At this time, an error value of the cumulative output of all layers in the first hybrid model relative to the cumulative original output (i.e., the difference between the final result of the first hybrid model and the final result of the original floating-point model) is calculated, which is the error value caused by the quantization layer of the first layer to the final result. For the second time, the second floating-point layer in the floating-point model is selected to be quantized, then a second hybrid model in which only the second layer is a quantization layer and all other layers remain floating-point layers is formed. An error value of the cumulative output of all layers in the second hybrid model relative to the cumulative original output is calculated, which is the error caused by the quantization layer of the second layer on the final result. By repeating the above steps and selecting a different floating-point layer for quantization each time, the error value caused by each quantization layer on the final result can be calculated.

In one embodiment, the quantization process may involve converting the data format of the floating-point layer from higher accuracy (such as floating-point FP16 or floating-point FP32) to lower accuracy (such as integer INT8 or integer INT16).

Step 103, sorting the calculated error values. After calculating the error value caused by each quantization layer on the final result, the quantization layers that have a greater effect on the error to the final result can be selected out by sorting the error values.

Step 104, quantizing all floating-point layers of the floating-point model, and restoring corresponding quantization layer(s) to floating-point layer(s) one by one in a descending order of the error values and calculating a difference between the cumulative output of all layers of the restored model and the cumulative original output until the difference is less than a preset loss threshold.

It should be understood that in the step 104, all floating-point layers of the floating-point model are all quantized to obtain a model with all quantization layers, the quantization layer with the highest error value is restored to the floating-point layer based on the descending order of the error values to form a first restored model, and a first difference between the cumulative output of all layers of the first restored model and the cumulative original output is calculated, and the difference is compared with a preset loss threshold. If the first difference is greater than the preset loss threshold, the quantization layer with the second highest error value is then restored to the floating-point layer based on the descending order of the error values to form a second restored model, and a second difference between the cumulative output of all the layers of the second restored model and the cumulative original outputs is again calculated, and the second difference is compared with the preset loss threshold. If the second difference is greater than the preset loss threshold, repeat the above steps until the difference between the calculated cumulative output and the cumulative original output is less than the preset loss threshold to obtain a target hybrid model.

In one embodiment, before quantizing all floating-point layers of the floating-point model, the last layer that is a normalized exponential function layer (such as softmax layer) of the floating-point model is removed. Correspondingly, after obtaining the target hybrid model, a normalized exponential function layer is added to the last layer of the obtained target hybrid model.

In order to better understand the technical solutions of this specification, the following will be described in conjunction with specific experimental data. The details listed in this embodiment are mainly for case of understanding and are not intended to limit the scope of protection of this application. The following is illustrated by taking neural network models Mobilenet_v2, Mnasmet0_5, Efficientnet-b0, Resnet50, shufflenct_v2_x1_0, and vgg16 as an example.

The accuracies of the hybrid models obtained by different neural network models through the method provided in this application are shown in Table 1 below, which only lists data corresponding to part of the quantization layers restored to floating-point layers. Taking the model mobilenet_v2 as an example, when the data format of all layers is floating-point FP32, the cumulative original output of the model is 0.71872. All layers are quantized and converted to the data format of integer INT8, and the cumulative output of all layers in this model is 0.68928. Data 48 in the table represents a restoration of the quantization (INT8) layer of the 48th layer to a floating-point layer (FP32), and the corresponding 0.68896 represents the cumulative output of all layers in this restored model. Data 0 in the table represents that after restoring the 48th layer to a floating-point layer, the quantization layer of the 0th layer is further restored to a floating-point layer, and the corresponding 0.69172 represents the cumulative output of all layers in this hybrid model after restoring the 48th and 0th layers, and so on for other data. It should be noted that the quantization layers are restored one by one in the order from the high to the low error values. From Table 1, it can be seen that after restoring the corresponding quantization layers to floating-point layers one by one in the order from the high to the low error values, the overall accuracy of the hybrid model generally shows an upward trend.

TABLE 1
Accuracies of Hybrid Models:

| | FP32 | INT8 | | | | | | | | |
|---|---|---|---|---|---|---|---|---|---|---|
| Model | accuracy | accuracy | Hybrid model | | | | | | | |
| Mobilenet_v2 | 0.71872 | 0.68928 | 48⁽¹⁾ | 0⁽²⁾ | 1 | 3 | 49 | 4 | 45 | 41 |
| | | | 0.68896 | 0.69172 | 0.6968 | 0.70126 | 0.70606 | 0.70848 | 0.7086 | 0.71026 |
| Mnasmet0_5 | 0.6775 | 0.61032 | 3 | 0 | 4 | 1 | 2 | 6 | 9 | 7 |
| | | | 0.58896 | 0.61464 | 0.64778 | 0.66282 | 0.66596 | 0.67072 | 0.67052 | 0.67196 |
| Efficientnet-b0 | 0.7611 | 0.61938 | 0 | 1 | 11 | 5 | 10 | 6 | 79 | 16 |
| | | | 0.62468 | 0.68688 | 0.68654 | 0.70372 | 0.72426 | 0.73172 | 0.74374 | 0.74852 |
| Shufflennet_v2_x1_0 | 0.69356 | 0.687 | 0 | 1 | 5 | 4 | 12 | 3 | 2 | 56 |
| | | | 0.67868 | 0.68392 | 0.68524 | 0.68794 | 0.68954 | 0.68904 | 0.68988 | 0.69024 |

### Regarding Error Local Effect of the BN Layers

The BN layers in a neural network are used to transform the inputs of the neurons to a Gaussian distribution with mean 0 and variance 1, and then shift and scale it. Its goal is that the sample feature distribution is more regular, facilitating parameter updating and model convergence.

Our research found that due the fact that the quantization error presents a Gaussian statistical distribution, and two Gaussian distributions superimposed are still a Gaussian distribution, so the sample feature distribution with quantization error is still a Gaussian distribution. As long as the quantization error distribution is similar to the original sample feature distribution, by calculating their KL (Kullback-Leible) divergence, it can be seen that the difference between the Gaussian distributions before and after quantization is not significant. Therefore, the BN layer can still play a good role in making the quantization distribution of each layer approximate the original distribution, which greatly reduces the effect on the next network layer.

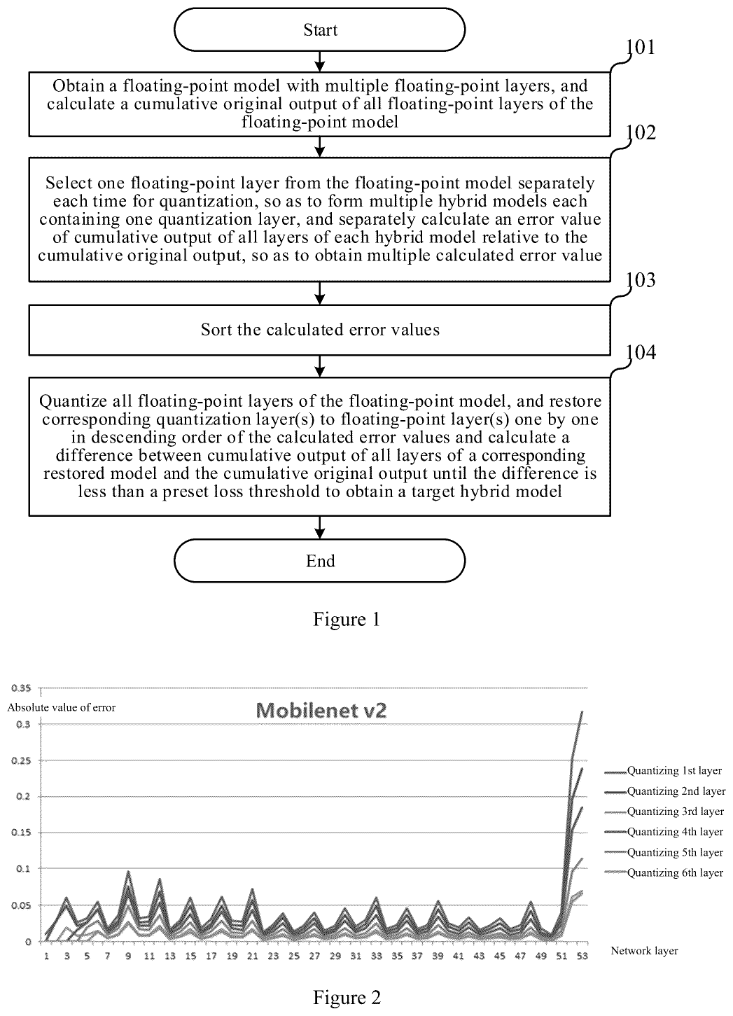

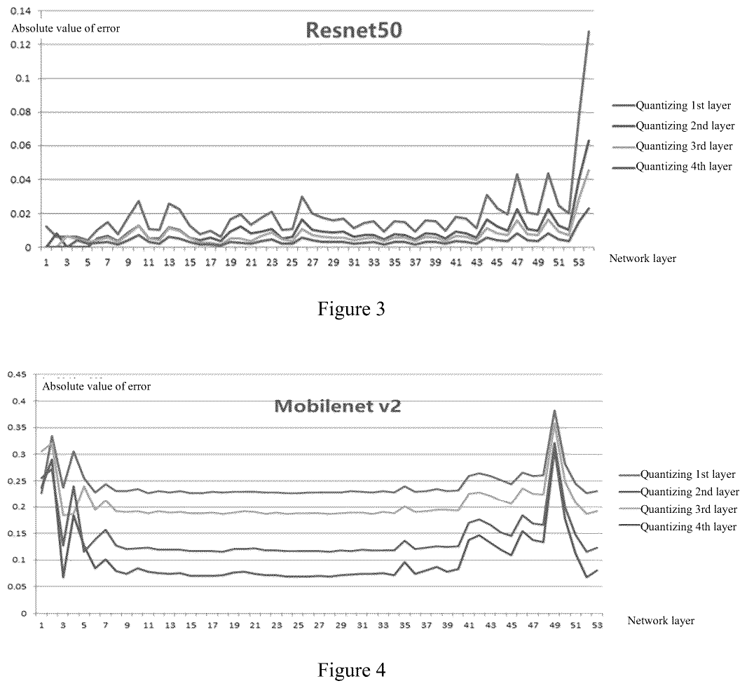

From FIGS. 2 and 3, it can be seen that due to the effect of the BN layer, the distribution of the quantization layer remains essentially the same and the effect on the subsequent network layers is minimal. We refer to this phenomenon as the Quantization Error Local Effect (QELE) caused by the BN layer.

### Regarding Interactions Between Quantization Layers

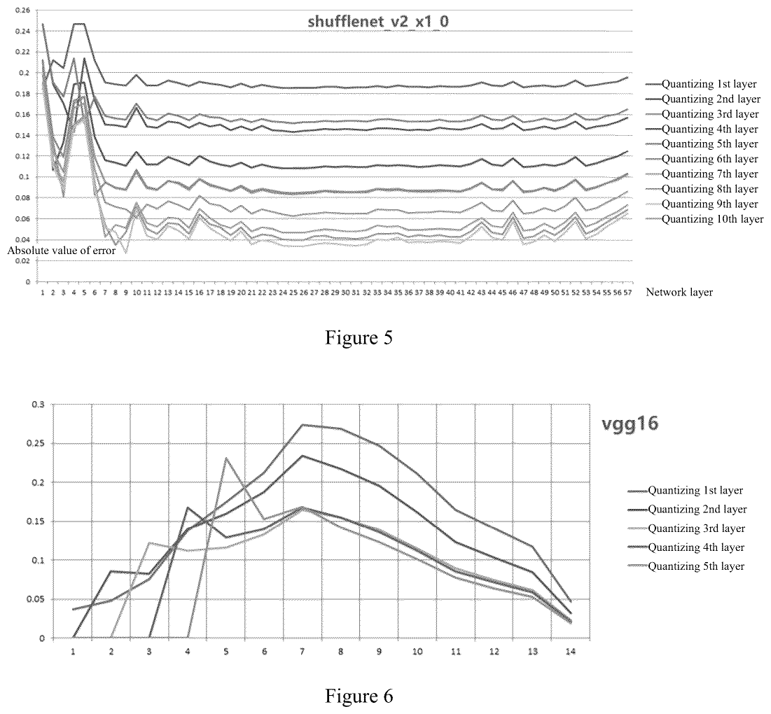

FIGS. 4 and 5 show the average quantization errors calculated for the last layer features after quantizing a certain layer and then quantizing each of the other layers separately of the Mobilenet_v2 model and the shufflenet_v2_x1_0 model, respectively, which can test interactions between quantizing one layer and quantizing other layers.

Taking the shuffleneet_v2ux1-0 model as an example, a curve at the topmost of FIG. 5 represents the average quantization errors calculated for the features of the last layer after quantizing the 1st layer and then quantizing the 1st to 57th layers respectively, and a total of 57 error values are obtained to form the curve, and other curves are analogous.

It can be seen that after layer-by-layer propagation and the interference from the quantization errors from other layers, the impact of the quantization error has the similar effect on the final layer and follows the same rule, which means that the magnitude of the effect of a certain quantization layer on the final result (relative to the magnitude of other layers) is not related to the interactions between other layers, nor is it related to the test set, but is only determined by the type of network model.

### Regarding Effects of BN Layers on Network Layer Errors

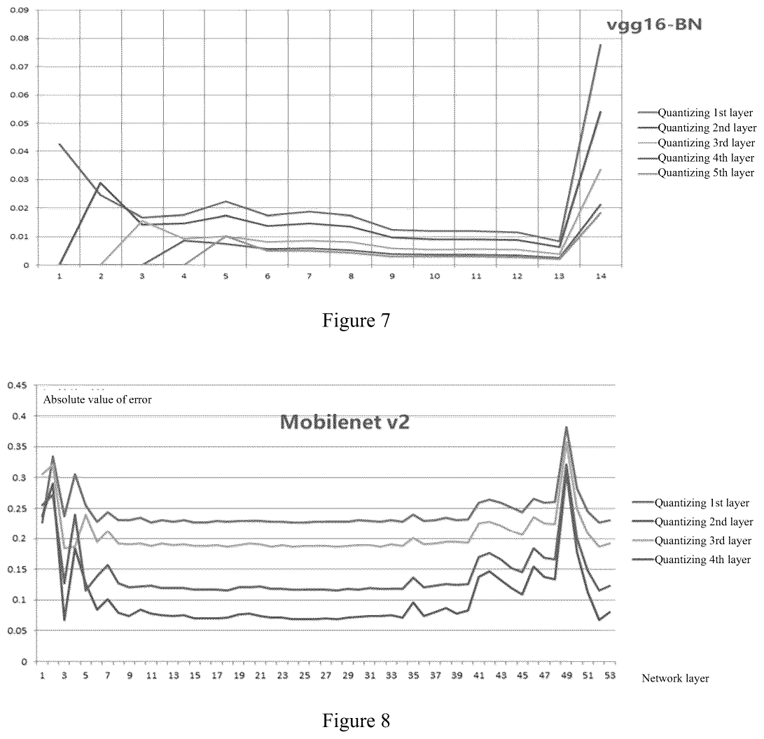

FIGS. 6 and 7 illustrate the difference between vgg16 with BN layers and vgg16 without BN layers, respectively. It can be seen that without the BN layers, the curve is parabolic in shape overall. This is because without the function of the BN layers, the quantization error appears to have a superposition effect, and the further of the layer, the larger of the superposition effect. Because of the network finally be trained to the minimization of the Loss, the sample feature deviation and variance (quantization error is also regarded as the sample feature deviation and variance) are trained to minimize, thus forming a constraint in the last layer. This constraint back-propagation encounters the quantization error superposition effect, and a peak is created, forming the parabolic shape. Networks with BN layers have flat curves because of the error localization effect.

### Regarding Effects of Softmax on Quantization Error

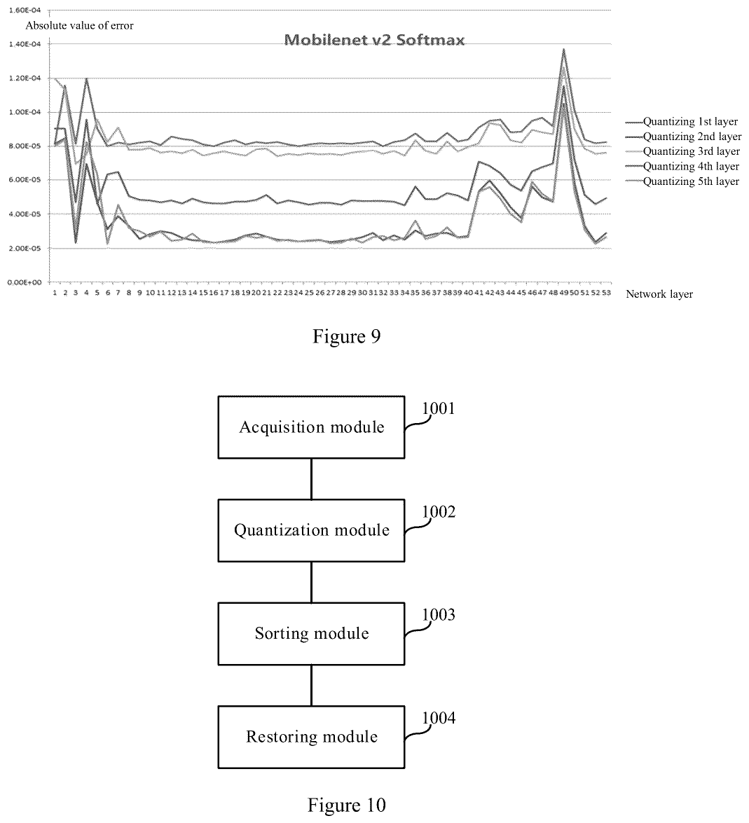

FIGS. 8 and 9 respectively show a difference between the last layer without softmax and the last layer with softmax. It should be noted that with softmax, the curves deviate is larger, so the feature of the penultimate layer of the model are actually taken as the results for comparison in FIG. 9. It can be seen from that the errors are significantly reduced after adding softmax.

The second embodiment of this application relates to a system for improving the accuracy of model quantization, as shown in FIG. 10. The system for improving the accuracy of model quantization comprises an acquisition module 1001, a quantization module 1002, a sorting module 1003, and a restoring module 1004. The acquisition module 1001 is configured to obtain a floating-point model with multiple floating-point layers, and calculate a cumulative original output of all floating-point layers of the floating-point model. The quantization module 1002 is configured to separately select one floating-point layer from the floating-point model for quantization each time, so as to form multiple hybrid models each containing one quantization layer, and separately calculate an error value of cumulative output of all layers of each hybrid model relative to the cumulative original output, so as to obtain multiple calculated error values. The sorting module 1003 is configured to sort the calculated error values. The restoring module 1004 is configured to quantize all floating-point layers of the floating-point model, and restore corresponding quantization layer(s) to floating-point layer(s) one by one in the descending order of the error values and calculate a difference between the cumulative output of all layers of each restored model and the cumulative original output until the difference is less than a preset loss threshold to obtain a target hybrid model.

In one embodiment, the floating-point model further comprises batch normalization layers, and each batch normalization layer is disposed behind the floating-point layer and is used to normalize an output of the floating-point layer.

In one embodiment, before the restoring module 1004 quantizes all floating-point layers of the floating-point model, the restoring module 1004 is further configured to remove the last layer that is a normalized exponential function layer of the floating-point model.

In one embodiment, upon the difference being less than the preset loss threshold, the restoring module 1004 is further configured to add a normalized exponential function layer to the current model as the last layer.

In one embodiment, the data format of the floating-point layer is: floating-point FP32 or floating-point FP16.

The first embodiment is a method embodiment corresponding to the present embodiment, and the technical details in the first embodiment can be applied to the present embodiment, and the technical details in the present embodiment can also be applied to the first embodiment.

The inventors of the present application have found that batch normalization of the neural network model can produce a good error local effect, which can effectively prevent the error from propagating backward in the network layers to produce the phenomenon of error superposition on each other. Based on this effect, we can then calculate the error caused by each quantization layer on the final result individually, so as to select out the quantization layers that have a greater effect on the final result, and restore the quantization layers that have a greater effect on the final result to the original floating-point number layers, thus obtaining an optimized target hybrid model. This calculation method is faster compared to the traditional method and can directly correspond to the final result, so the optimal target hybrid model can be selected more intuitively.

The present application obtains an optimized target hybrid model by individually calculating the error caused by each quantization layer to the final result so as to select the quantization layers that having a large effect on the final result, and restoring the quantization layers that having a greater effect on the final result to original floating-point layers. This calculation method is faster compared to the traditional method and can directly correspond to the final result, so the optimal target hybrid model can be selected more intuitively. The application has a very wide applicability, and can be applied to any network layer that combines convolutional layers and batch normalization layers, and most of the cases in the practical applications meet the condition.

It should be noted that those skilled in the art should understand that the implementation functions of the modules shown in the embodiments of the above system for improving the accuracy of model quantization can be referred to the relevant description of the foregoing method for improving the accuracy of model quantization. The functions of each module shown in the above embodiments of the system for improving the accuracy of model quantization can be implemented by a program (executable instructions) running on the processor, and can also be achieved through specific logical circuits. The system for improving the accuracy of model quantization described above for embodiments of the present application may also be stored in a computer-readable storage medium if it is implemented in the form of a software function module and sold or used as a stand-alone product. Based on this understanding, the technical solutions of the embodiments of the present application can be embodied in the form of software products in essence or part of contributions to the prior art. The computer software product is stored in a storage medium, and includes several instructions to enable a computer device (which may be a personal computer, server, or network device, etc.) to perform all or part of the methods described in the embodiments of the present application. The foregoing storage media include various media that can store program codes, such as a U disk, a mobile hard disk, a read-only memory (ROM, Read Only Memory), a magnetic disk, or an optical disk. In this way, the embodiments of the present application are not limited to any specific combination of hardware and software.

Correspondingly, the embodiments of the present application also provide a computer-readable storage medium in which computer-executable instructions are stored. When the computer-executable instructions are executed by a processor, the method embodiments of the present application are implemented. The computer-readable storage media comprises permanent and non-permanent, removable and non-removable media which can be used by any method or technology to implement information storage. Information can be computer-readable instructions, data structures, program modules, or other data. Examples of computer-executable storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, read-only optical disc read-only memory (CD-ROM), digital multifunctional optical disc (DVD) or other optical storage, magnetic cartridge tapes, magnetic tape disk storage or other magnetic storage devices, or any other non-transport media that can be used to store information that can be accessed by computing devices. As defined herein, a computer-readable storage medium does not include transient computer-readable media (transitory media), such as modulated data signals and carriers.

It should be noted that in this specification of the application, relational terms such as the first and second, and so on are only configured to distinguish one entity or operation from another entity or operation, and do not necessarily require or imply any such actual relationship or order between these entities or operations. Furthermore, the term “comprises” or “comprising” or “includes” or any other variations thereof is intended to encompass a non-exclusive inclusion, such that a process, method, article, or device that comprises multiple elements include not only those elements but also other elements, or elements that are inherent to such a process, method, item, or device. Without more restrictions, the element defined by the phrase “comprise(s) a/an” does not exclude that there are other identical elements in the process, method, item or device that includes the element. In this specification of the application, if it is mentioned that an action is performed according to an element, it means the meaning of performing the action at least according to the element, and includes two cases: the action is performed only on the basis of the element, and the action is performed based on the element and other elements. Multiple, repeatedly, various, etc., expressions include 2, twice, 2 types, and 2 or more, twice or more, and 2 types or more types.

All documents mentioned in this specification are considered to be included in the disclosure of this application as a whole, so that they can be used as a basis for modification when necessary. In addition, it should be understood that the above descriptions are only preferred embodiments of this specification, and are not intended to limit the protection scope of this specification. Any modification, equivalent replacement, improvement, etc. made within the spirit and principle of one or more embodiments of this specification should be included in the protection scope of one or more embodiments of this specification.

In some cases, the actions or steps described in the claims can be performed in a different order than in the embodiments and still achieve desired results. In addition, the processes depicted in the drawings do not necessarily require the specific order or sequential order shown in order to achieve the desired results. In some embodiments, multitasking and parallel processing are also possible or may be advantageous.

What is claimed is:

1. A method for improving accuracy of model quantization, comprising:
obtaining a floating-point model with multiple floating-point layers, and calculating a cumulative original output of all floating-point layers of the floating-point model;
selecting one floating-point layer from the floating-point model separately each time for quantization, so as to form multiple hybrid models each containing one quantization layer, and separately calculating an error value of cumulative output of all layers of each hybrid model relative to the cumulative original output, so as to obtain multiple calculated error values;
sorting the calculated error values; and
quantizing all floating-point layers of the floating-point model, and restoring corresponding quantization layer(s) to floating-point layer(s) one by one in descending order of the calculated error values and calculating a difference between cumulative output of all layers of a corresponding restored model and the cumulative original output until the difference is less than a preset loss threshold to obtain a target hybrid model.

2. The method for improving the accuracy of model quantization according to claim 1, wherein the floating-point model further comprises batch normalization layers, each disposed behind the floating-point layer and used to normalize an output of the floating-point layer.

3. The method for improving the accuracy of model quantization according to claim 1, wherein before quantizing all floating-point layers of the floating-point model, the method further comprises removing the last layer that is a normalized exponential function layer of the floating-point model.

4. The method for improving the accuracy of model quantization according to claim 3, wherein upon the difference being less than the preset loss threshold, the method further comprises: adding a normalized exponential function layer to the target hybrid model as the last layer of the target hybrid model.

5. The method for improving the accuracy of model quantization according to claim 1, wherein data format of the floating-point layer is: floating-point FP32 or floating-point FP16.

6. A system for improving accuracy of model quantization, comprising:
an acquisition module, configured to obtain a floating-point model with multiple floating-point layers, and calculate a cumulative original output of all floating-point layers of the floating-point model;
a quantization module, configured to select one floating-point layer from the floating-point model separately each time for quantization, so as to form multiple hybrid models each containing one quantization layer, and separately calculate an error value of cumulative output of all layers of each hybrid model relative to the cumulative original output, so as to obtain multiple calculated error value;
a sorting module, configured to sort the calculated error values; and
a restoring module, configured to quantize all floating-point layers of the floating-point model, and restore corresponding quantization layer(s) to floating-point layer(s) one by one in descending order of the calculated error values and calculate a difference between cumulative output of all layers of a corresponding restored model and the cumulative original output until the difference is less than a preset loss threshold to obtain a target hybrid model.

7. The system for improving the accuracy of model quantization according to claim 6, wherein the floating-point model further comprises batch normalization layers, each disposed behind the floating-point layer and used to normalize an output of the floating-point layer.

8. The system for improving the accuracy of model quantization according to claim 6, wherein before quantizing all floating-point layers of the floating-point model, the restoring module is further configured to remove the last layer that is a normalized exponential function layer of the floating-point model.

9. The system for improving the accuracy of model quantization according to claim 8, wherein upon the difference being less than the preset loss threshold, the restoring module is further configured to add a normalized exponential function layer to the target hybrid model as the last layer of the target hybrid model.

10. The system for improving the accuracy of model quantization according to claim 6, wherein data format of the floating-point layer is: floating-point FP32 or floating-point FP16.
